(19) United States
(12) Patent Application Publication
(10) Pub. No.: US 2024/0180209 A1
(43) Pub. Date: Jun. 6, 2024

(54) COOKING SESSION RE-CREATION SYSTEM

(71) Applicants: BSH Home Appliances Corporation, Irvine, CA (US); BSH Hausgeräte GmbH, Munich (DE)

(72) Inventors: Garrett Bentley, Knoxville, TN (US); Luc Lam, Irvine, CA (US)

(21) Appl. No.: 18/075,484

(22) Filed: Dec. 6, 2022

(51) Int. Cl. A23L 5/10; G05B 19/042

(52) U.S. Cl. CPC A23L 5/17; G05B 19/042; A23V 2002/00; G05B 2219/2643

(57) ABSTRACT

A computer-implemented method for operating a cooking appliance may include automatically recording, using a controller of a cooking appliance, a series of user inputs at the cooking appliance during a cooking process of a food item. Based on the plurality of sequential user inputs, a cooking session program is automatically generated, the cooking session program being configured to re-create the cooking process by automatically controlling the cooking appliance.

### FIELD

This disclosure relates to systems and methods for operating cooking appliances, such as ovens.

### INTRODUCTION

Cooking appliances continue to gain more capabilities and features as technology progresses, such as smart cooking features including food recognition. Nevertheless, adaptation of these new features by users may progress slower than the developments. For instance, users may avoid using new features on smart cooking appliances, believing that such features would stifle their own cooking habits and fail to match their preferences.

### SUMMARY

The present disclosure provides systems, apparatuses, and methods relating to cooking session re-creation system.

In some examples, a computer-implemented method for operating a cooking appliance may include: automatically recording, using a controller of a cooking appliance, a plurality of sequential user inputs at the cooking appliance during a cooking process of a food item; automatically generating, based on the plurality of sequential user inputs, a cooking session program configured to re-create the cooking process by automatically controlling the cooking appliance; and automatically controlling the cooking appliance to re-create the cooking process using the cooking session program.

In some examples, a computer-implemented method for operating a cooking appliance may include: automatically recording, using processing logic, a plurality of sequential user inputs at the cooking appliance during a cooking process of a food item; documenting a characteristic of a finished version of the food item by automatically generating an image of the food item at an end stage of the cooking process; automatically generating, using the processing logic and based on the recorded user inputs, a cooking session program configured to re-create the cooking process, including the sequential user inputs, by automatically controlling the cooking appliance; and automatically controlling the cooking appliance to re-create the cooking process using the cooking session program, wherein the processing logic automatically modifies the cooking session program to obtain the characteristic of the finished version of the food item.

In some examples, a computer-implemented method for operating a cooking appliance may include: automatically recording, using processing logic, a plurality of sequential user inputs at the cooking appliance during a cooking process of a food item; automatically recording, using one or more sensors, a plurality of characteristics of the food item and the cooking appliance during the cooking process; automatically generating, based on the recorded user inputs, the recorded characteristics of the food item, and the recorded characteristics of the cooking appliance, a cooking session program configured to re-create the cooking process by automatically controlling the cooking appliance.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram depicting an illustrative cooking session re-creation system.

FIG. 2 is a schematic diagram depicting an illustrative cooking session.

FIG. 3 is a flow chart depicting steps of a first illustrative method of recording a user's cooking actions according to the present teachings.

FIG. 4 is a flow chart depicting steps of a second illustrative method of recording a user's cooking actions according to the present teachings.

FIG. 5 is a flow chart depicting steps of a third illustrative method of recording a user's cooking actions according to the present teachings.

FIG. 6 is a flow chart depicting steps of an illustrative method of organizing recorded cooking sessions according to the present teachings.

FIG. 7 is a schematic diagram of a first illustrative session selection screen as described herein.

FIG. 8 is a schematic diagram of a second illustrative session selection screen as described herein.

FIG. 9 is a flow chart depicting steps of an illustrative cooking session re-creation.

FIG. 10 is a flow chart depicting steps of a first illustrative cooking session modification.

FIG. 11 is a flow chart depicting steps of a second illustrative cooking session modification.

FIG. 12 is a schematic diagram of an illustrative machine learning algorithm suitable for use with aspects of the present disclosure.

### DETAILED DESCRIPTION

Various aspects and examples of a cooking session re-creation system configured to record events and parameters related to a cooking session, save the events and parameters as a session history, and re-create the cooking session are described below and illustrated in the associated drawings. Unless otherwise specified, a cooking session re-creation system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first,” “second,” and “third” are used to distinguish or identify various members of a group, or the like, and are not intended to show serial or numerical limitation.

“AKA” means “also known as,” and may be used to indicate an alternative or corresponding term for a given element or elements.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, cooking session re-creation systems of the present disclosure are configured to record user-inputs during cooking, save the recordings as a cooking session, and re-create the user's cooking process from the generated cooking session. The automatic creation of cooking sessions encourages experimentation during cooking and improves the ease of utilizing available appliance functions (e.g., the sensors available on smart ovens and the like). During the cooking process, a user can cook normally while the system documents the cooking process for later reference and use. The re-creation function enables a user to have cooking appliances (e.g., ovens, stovetops, all-in-one cookers, etc.) automatically cook based on the user's own process, therefore easing the challenge of cooking while maintaining user preferences.

To record cooking sessions, the system includes a cooking session recorder device and/or application in communication with one or more cooking appliances and/or sensors. The recorder may be a component and/or function of a cooking appliance, for example, an electronic controller of an oven. The recorder documents a user's inputs and/or interactions with one or more cooking appliances. Each recordable input and/or interaction is registered as a recordable event and automatically documented. Such inputs and/or interactions include, but are not limited to, selecting a cooking mode, selecting or adjusting a mode setting, entering a temperature, and/or entering a cooking timer. In some examples, recording includes documenting a user interaction with any component suitable for controlling a cooking device, such as a button, knob, switch, etc. For example, the user pressing a “Bake” button on an oven may be recorded as selecting the cooking mode. In some examples, remote control of a cooking appliance is recorded, such as activating the cooking appliance using a smartphone. Additionally or alternatively, user interactions with the physical cooking appliance, such as opening and closing doors, may be recorded.

In some examples, each of a user's inputs and/or interactions are cataloged as a cooking event in the cooking process by the recorder device. A cooking event contains related inputs and actions gathered into a step. For example, a user setting a timer may involve the user pressing a “timer” button and then entering the time. These inputs are cataloged and recorded as part of the same cooking event. Parameters may be assigned to a cooking event. For example, a setting-a-timer cooking event may have a parameter for the entered time (i.e., duration). The steps, with operations and parameters, contain the documented user's inputs and/or interactions translated into an instructional format that may be utilized to automatically control one or more appliances.

An illustrative example of recording is as follows: In a first step, the user selects the bake function on an oven and, in a second step, sets the temperature to 375 degrees. The recorder device in this example saves the recorder information as “step 1: set oven to bake; step 2: set temperature to 375 degrees.” In this example, setting the oven to bake and setting the temperature are cooking events, and each event serves as a step in the cooking process. The second step of setting the temperature has an associated cooking parameter of the temperature in degrees (e.g., Fahrenheit). While the example above illustrates one viable way of categorizing a user's interactions, other ways of categorizing are possible.

Along with recording a user's interactions with the one or more cooking appliances, the recorder may document information on the cooking process utilizing various cooking sensors. These sensors may be components of a cooking appliance and/or components of the recorder. In some examples, the cooking appliance, the sensors, and the recorder device are all part of the same device. Sensors include, but are not limited to, temperature sensors, humidity sensors, position sensors, and/or device performance sensors (e.g., sensors measuring various aspects of the performance of a cooking appliance). Utilizing the sensor information, the recorder may provide additional information for recorded cooking events (e.g., the event of setting a mixer to high speed is supplemented with sensor data on the actual speed in revolutions per minute (RPM) of the mixer). In some examples, the sensor information is presented to or accessible by the user, e.g., to better understand their cooking process. For example, the actual measured time that the user cooks a food item may provide more precise context when compared to what the user may have done based on experience or intuition.

Recorded user input and sensor information are saved in a cooking session, and may be saved to the recorder, a memory of a cooking appliance, and/or to a cloud service. The user may access the saved cooking sessions to review and/or modify previous cooking sessions. Accessing the saved cooking sessions may be done through a display connected to the recorder device, e.g., using a graphical user interface (GUI). A user can access saved cooking sessions in a session history. The session history may contain an essentially unlimited number of cooking sessions or may be configured to keep only a limited number (either by choice of the user or by automatic managing).

A saved cooking session includes a set of operational instructions usable for automatic control of one or more cooking appliances to recreate the cooking events represented by the cooking session. In some examples, the instructions are the recorded cooking events separated into corresponding cooking steps, such as turning a burner on, changing temperature, opening a door, etc. An event may have an associated parameter in the instructions. For example, a “set temperature” event may have an associated setting corresponding to the recorded temperature, and this information would be available in the instructions of the cooking session. In some examples, the user may follow the instructions displayed with respect to the cooking session to re-create the food (e.g., meal) manually. In some examples, options are provided for modifying the cooking session, e.g., editing the steps, adding notes (e.g., personal notes regarding the cooking process), and adding or deleting steps. The user may utilize these options to alter and personalize the cooking session.

The cooking session re-creation system is configured to re-create, reenact, or otherwise simulate recorded cooking sessions. During re-creation, the recorder device and/or the cooking appliance provides instructions and/or automatically cooks the food item. For example, during re-creation of a cooking session where roast chicken was cooked, an oven is automatically controlled to start heating to the correct temperature. Once the temperature is reached, the oven and/or the recorder will signal the user to place the chicken into the oven. In some examples, the recorder continues to record a user's actions while a cooking session is being re-created. If the user makes changes to the recipe during recreation, these changes may be recorded and used to create a new cooking session.

Cooking sessions are modifiable after creation. Modifications include changing any aspect of the cooking session, such as adding extra steps or altering the cooking outcome. In response to receiving a modification request the recorder and/or cooking appliance may first match the cooking session to an existing or pre-made cooking program (e.g., the system finds a pre-made cooking program with substantially similar instructions to the cooking session). In this context, a cooking program is a cooking procedure that a user can activate to automatically cook a food item. By matching the cooking session to a cooking program, the recorder may modify cooking sessions using programming logic configured to modify cooking programs. For example, the modifications used to achieve different degrees of crispiness in a roast chicken cooking program may be used to achieve the same different degrees of crispiness in a matched cooking session. In some examples, a substantially similar cooking program replaces the cooking session and then modified to match the user's requested cooking outcome. Additionally or alternatively, the recorder device may be configured to make modifications to cooking sessions without matching the cooking sessions to a cooking program. Modifications may be done with any suitable programming logic configured to predict how a cooking outcome is affected by changing of cooking parameters.

Aspects of cooking session re-creation systems may be embodied as a computer method, computer system, or computer program product. Accordingly, aspects of the cooking session re-creation system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the cooking session recreation system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of cooking session recreation system may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C #, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the cooking session recreation system may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the cooking session recreation system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative cooking session recreation systems as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative First Cooking Session Re-creation System

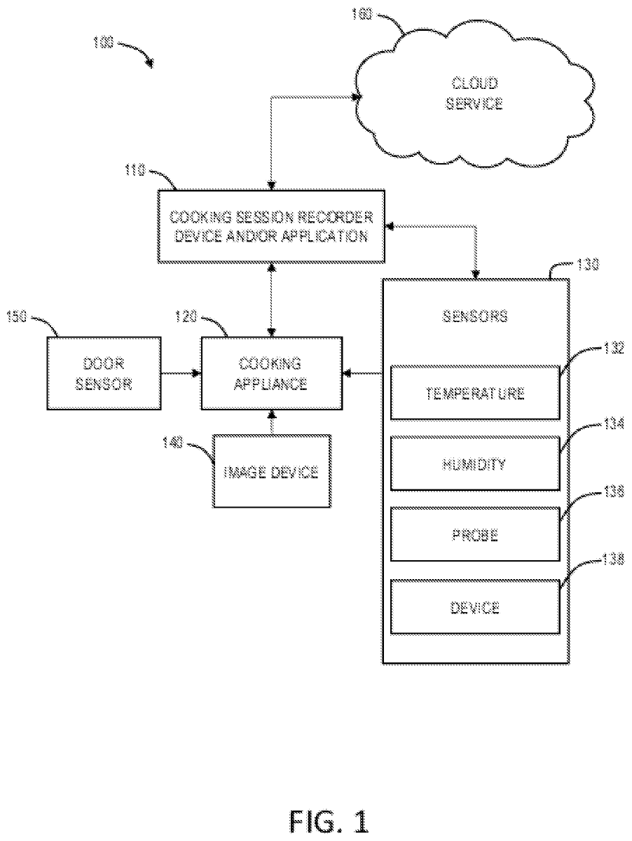

As shown in FIG. 1, this section describes an illustrative first cooking session re-creation system 100. Cooking session re-creation system 100 is an example of the cooking session re-creation systems described above.

System 100 includes a cooking session recorder device and/or application 110. Recorder 110 is in communication with at least one cooking appliance 120. Recorder 110 may communicate with any suitable devices and/or applications configured to documenting a user's cooking actions, such as sensors 130 and imaging device 140. In some examples, recorder 110 is an electronic controller in wireless communication with multiple cooking appliances 120. Additionally or alternatively, recorder 110 may be a component of cooking appliance 120 (e.g., an electronic controller of the oven). In some examples, there may be multiple recorders 110 some or all of which may be configured to document a user's actions. In some examples, recorder 110 includes a software application configured to turn any standard smart device into a recording device. For example, recorder 110 may comprise an app available for installation on a user's phone that allows the users phone to function as a recorder device and document the user's inputs and/or interactions with cooking appliances. Communication between recorder 110 and cooking appliances may be facilitated through a home network.

The user may interact with the recorder 110 through a display and/or GUI on cooking appliance 120 and/or recorder 110. In some examples, the user can control and/or interact with recorder 110 through a smart phone, a smart watch, and/or other such controllers. In some examples, a downloadable application facilitates communication with recorder 110 (e.g., allows a user to interact with the recorder device through their phone after downloading an application).

To record cooking sessions, recorder 110 documents a user's interactions and/or inputs with one or more cooking appliances 120. In some examples, recording is done through documenting a user's interaction with any component suitable for controlling a cooking device, such as a button, knob, switch, electronic controller, etc. For example, the user tapping or pressing a “Bake” button on an oven is recorded as a user input (in this example, the input is selecting a cooking mode). Remote control of a cooking appliance may be recorded, such as activating the cooking appliance using a smart phone. In some examples, cooking appliance 120 communicates the user's inputs and/or interactions to recorder 110. For each input, interaction, and/or operation of the cooking process, recorder 110 may be configured to document the time and/or duration, e.g., utilizing timestamps. For example, recorder 110 may include an internal clock or timer to measure the duration and/or may retrieve duration measurements from other components, such as cooking appliances 120. Additionally or alternatively, cooking appliance 120 may have a timer or clock for documenting durations.

Cooking appliances 120 include any device configured to cook, bake, and/or otherwise process a food item, such as ovens, stovetops, all-in-one cookers, etc. In some examples, cooking appliance 120 includes a smart appliance configured to execute cooking programs and other automatic programming. Components utilized in cooking session recreation system 100 may include one or more components of cooking appliance 120. For example, recorder 110, sensors 130, imaging device 140, and door sensor 150 may be included components and/or applications of cooking appliance 120. Accordingly, the recording and re-creation methods described in this example may be performed by cooking appliance 120.

Recorder 110 and/or cooking appliances 120 may receive data about food items and operations from various other devices, including sensors 130, imaging device 140, and door position sensors 150. Sensors 130 may include temperature sensors 132, humidity sensors 134, probe 136, and device sensors 138. Sensor(s) 130 include any suitable device configured to measure or detect food item characteristics (e.g., temperature) and/or cooking appliance states, characteristics, or operations. In some examples, sensor(s) 130 are wired to the cooking appliance and communicate directly. Additionally or alternatively, sensors 130 may transmit data wirelessly to recorder 110 and/or cooking appliances 120. Device sensor 138 may be configured to measure characteristics of the cooking appliance (such appliance specifications) as well as characteristics of attachments and/or accessories used during the cooking process. Imaging device 140 may include any device configured to perform video imaging or photography. In some examples, image device 140 is a camera that takes videos of the food item while the food item cooks. Door position sensor 150 may include any suitable sensor configured to detect the position and/or movement of a door or access point of a cooking appliance (e.g., open or closed). In some examples, in response to the user opening and then closing an appliance door, door position sensor 150 sends a signal to recorder 110 and/or cooking appliance 120 to record the opening and closing event.

Components of cooking session re-creation system 100 may be in communication with a cloud service 160. Cooking sessions may be saved on cloud service 160. In some examples, a user may be able to share their recorded cooking sessions on cloud service 160, such that other users can access and utilize the recorded cooking sessions. In some examples, recorder 110 is an application within cloud service 160 that communicates (e.g., remotely) with cooking appliance 120 to record cooking sessions.

### B. Illustrative Cooking Session

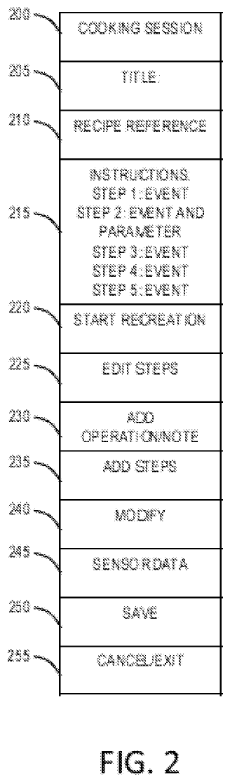

As depicted in FIG. 2, this section describes an illustrative cooking session 200. Cooking session 200 is an example of the cooking sessions described in the Overview above.

Cooking session 200 may include any suitable data or information stored in a data store, comprising information gathered by cooking sessions re-creation system 100 (e.g., by the recorder) and configured to control cooking appliance(s) to re-create cooking session 200. The illustrative cooking session 200 depicted in FIG. 2 may represent a user's view of a cooking session (e.g., on a cooking session information screen), although other formats may be used. The user may access cooking session 200 using the recorder device, a cooking appliance, and/or the user's phone. In some examples, cooking session 200 comprises a menu and has buttons or other interactive controls, facilitating user navigation with respect to components of the cooking session.

Cooking session 200 includes a description or title 205 identifying the session, and which may be used to search and/or organize cooking sessions (e.g., alphabetically). In some examples, title 205 is entered by the user. In some examples, title 205 is automatically assigned, e.g., based on recognition by the cooking appliance and/or recorder device (e.g., image recognition using a camera and/or analyzing similarities between current cooking session and previous cooking sessions).

In some examples, the cooking session includes a recipe reference 210 (e.g., a link to an online resource regarding the recipe being followed or emulated). The user may provide recipe reference 210 at any time, and may be prompted by the system to do so. In some examples, cooking session recreation system 100 may provide or suggest recipe reference 220 based on automatic recognition. Cooking appliance 120 and/or recorder 110 may be configured to recognize a food item based on a user's inputs and/or sensor information (e.g., images from imaging device 140). If the user has cooked a particular food item before and supplied recipe reference 210, system 100 may automatically supply the same reference if the user's inputs for the cooking sessions are substantially similar. Such automatic recognition and/or assigning may be done using any suitable programming logic, e.g., using a trained machine learning model.

Cooking session 200 contains instructions 215, organized in any suitable manner to reflect the user's recorded inputs and/or interactions, as well as the operations of the cooking process. In some examples, the user's interactions and/or inputs with cooking appliances are divided into steps (e.g., step 1, step 2, etc.). Each step has a cooking event including an input, action, and/or operation, such as turning a burner on, setting a temperature, opening a door, etc. Each event may have an associated parameter. For example, a temperature setting event may have a parameter of temperature in degrees (e.g., 375 degrees F.) associated with the event. As an illustrative example, setting the oven to bake and then setting the temperature are considered cooking events, and each event acts as a step in the cooking process. The second step, setting the temperature, has an associated cooking parameter of the temperature in degrees. In some examples, instructions 215 provide the duration or timing of each cooking event, e.g., using timestamps. Because the cooking events are intended to be re-created, these timestamps may be relative (e.g., relative to the start time to indicate elapsed time or relative to the finish time to indicate time remaining) rather than actual time-of-day values. These timestamps may be displayed with each cooking event and may collectively provide an estimate for the total preparation time. Additionally or alternatively, one or more instructions 215 may represent operational instructions. That is, instructions 215 may be the commands used to control a cooking appliance, and may be emulated or rerun during the re-creation process.

Re-creation of cooking session 200 may be initiated from a cooking session 200 information screen. In some examples, cooking session 200 has a start button 220 configured to begin the cooking process. A user may initiate a cooking session by accessing cooking session 200 and selecting start 220. Once selected, the operational instructions are sent to corresponding cooking appliances. In some examples, the user may schedule the cooking session to be re-created at a later time.

The cooking session further includes functionality to edit the steps 225, add notes 230 (e.g., personal notes regarding the cooking process), and/or add steps 235. A modify option 240 is configured to facilitate altering the cooking outcome of the food item. As used herein, cooking outcomes are the final characteristics or qualities of a cooked food item, such as doneness, crispiness, final temperature, etc.

Cooking session 200 includes sensor data 245. The user may utilize sensor data 245 to view data recorded during the cooking session. Such data may be presented as a single measurement (e.g., final temperature: 168 degrees). Data may further be represented graphically. The sensor information may be utilized by the user to understand their cooking process better (e.g., actual time that the user cooks a food item on a stove-top may give precision to what a user may otherwise have done by feel).

An accessed cooking session 200 includes a save 250 and a cancel/exit 255 feature to save and exit cooking session 200, respectively.

### C. Illustrative Method for Recording a Cooking Session

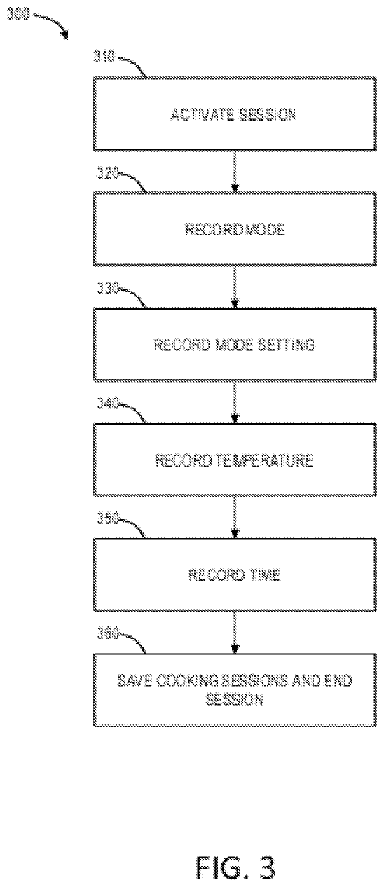

This section describes steps of a first illustrative method 300 for recording a user's cooking actions utilizing a cooking session recorder; see FIG. 3. Aspects of cooking session re-creation system 100 and cooking session 200 may be utilized in the method steps described below. Where appropriate, reference may be made to components and systems that may be used in carrying out each step. These references are for illustration, and are not intended to limit the possible ways of carrying out any particular step of the method.

FIG. 3 is a flowchart illustrating steps performed in an illustrative method, and may not recite the complete process or all steps of the method. Although various steps of method 300 are described below and depicted in FIG. 3, the steps need not necessarily all be performed, and in some cases may be performed simultaneously or in a different order than the order shown.

Step 310 of method 300 includes activating the session and beginning the recording process. Activation of the session may start upon the activation of cooking appliance(s) 120 (e.g., the recording begins in response to a cooking appliance being activated). In some examples, activation begins manually, upon the user selecting a record function on cooking appliance 120 and/or recorder 110. For example the user may turn a cooking appliance on and then navigate to a menu to select a recorder function. Step 310 may further include cooking appliance 120 and/or recorder 110 activating any sensors (such as sensors 130 and/or door sensor 150) connected to the cooking appliance and/or the cooking session re-creation system.

Step 320 includes recording the mode selected by the user. Modes include any function of a cooking appliance related to process and/or cook a food item. For example, an oven may have a bake mode, a broil mode, a reheat mode, etc. A user selecting a mode on the cooking appliance (e.g., pressing a button on the cooking appliances that controls the mode) is recorded as an input by the cooking appliance and/or the recorder. In some examples, the user selects a mode from a menu of possible modes (e.g., the user is remotely controlling a cooking appliance from a smart phone and navigates a menu of possible cooking modes); the user's selection is recorded by the remote device and/or the recorder. The recorded mode may be changed at any point. For example, if the user selects and then cancels out of a mode and chooses another one, the cooking session re-creation system may remove the previously entered mode and instead record the other selected mode. In some examples, a specific part and/or area of the cooking appliance is recorded. For example, the position of an oven rack may be recorded along with recording the mode being set to broil.

Step 330 includes recording the mode settings selected by the user. Mode settings include any function of the cooking appliance related to altering and/or adjusting the selected mode. For example, a stirring mode of a cooking appliance may have a stirring-speed setting with different speed levels. In some examples, a mode setting is based on the food item being cooked and/or the cooking accessories being used. For example, a boil mode of a cooking appliance may have a mode setting configured to boil water and another mode setting configured to heat milk. Using cooking accessories may change the mode setting depending on what attachments and/or accessories are used for a selected mode. For example, an appliance may have different settings for a stirring mode depending on whether a liquid stirring attachment, or a spatula-stirring attachment is used (e.g., different speeds and/or stirring patterns). Similar to recording a mode, a user's interactions and/or inputs with a cooking appliance may be recorded for both direct and remote interactions.

Step 340 includes recording the temperature selected by the user. Recording the temperature may include both recording a temperature event and a temperature parameter. For example, the user entering a temperature is recorded as a temperature event and the final temperature is recorded as the associated parameter. Similar to recording a mode, a user's interaction and/or input with a cooking appliance may be recorded for both direct and remote interactions. In some examples, the user selects an option with a pre-established temperature (e.g., a broil option with a set temperature of 500 degrees). In some examples, the temperature option may be recorded as a temperature event without any recorded parameters (e.g., only “broil” is recorded). In some examples, both the temperature option and the pre-established temperature are recorded (e.g., “select broil” is recorded as the temperature event and the associated parameter is 500 degrees).

Step 350 includes recording the time or duration selected by the user. Recording the time may include both recording a time event and a time parameter. For example, a user selecting a “set timer” is recorded as a time event and the entered time is recorded as the associated parameter. In some examples, the user may select an option that has a pre-established time associated with it. For example, a user may select a “reheat” option that has a set time. In this example, only a time event may be record (e.g., only recording that the user selected the “reheat” option). Alternatively, the time event with an associated set time is recorded with the associated set time recorded as a parameter (e.g., both the user selecting the “reheat” option and that the “reheat” option has a time of 30 seconds is recorded). Some cooking functions may have both a set temperature and time. With such functions, the recorder may assign both parameters to a single cooking event.

In some examples, the recorder documents the duration and/or provides timestamps for each recorded mode, mode setting, and/or temperature. The duration of some cooking operations, such as “bake,” may be determined by another operation (e.g., “setting a timer for 25 minutes”). In some examples, the duration is documented automatically by the recorder. For example, the time a user cooks a food item on a high temperature setting is recorded automatically without the presence of a user-set timer. Cooking appliance operations that require a setup period, such as heating an oven to the requested temperature, may have the setup period duration recorded as well and, in some examples, added to the total duration time for the cooking process.

Step 360 includes saving all recorded information and ending the session. The information documented by the recorder device is saved as a cooking session. Additional information may be provided by the user before the cooking session is saved. Such information includes notes provided by the user about the cooking session. For example, before saving, the recorder may request the user to add notes and/or approve the saving of the recorded cooking session. Recorded cooking sessions may be saved to the recorder, a memory of a cooking appliance, and/or to a cloud service. In some examples, the cooking session is an automatic program configured to re-create the user's cooking process. In other words, the recorded user's inputs become a program stored on cooking appliance 120 and/or recorder 110, and the program automatically controls one or more cooking appliances to re-create the user cooking process.

Before being saved, the user may be requested to review the cooking session to assure that the recorded information is correct. In some examples, where multiple food items were cooked, the user is asked to manually separate the different recorded actions to create multiple cooking sessions or to keep the multiple food items as one single cooking session (e.g., cooking two items in the oven at the same time could be saved as a single cooking session).

### D. Additional Illustrative Methods for Recording of Cooking Sessions

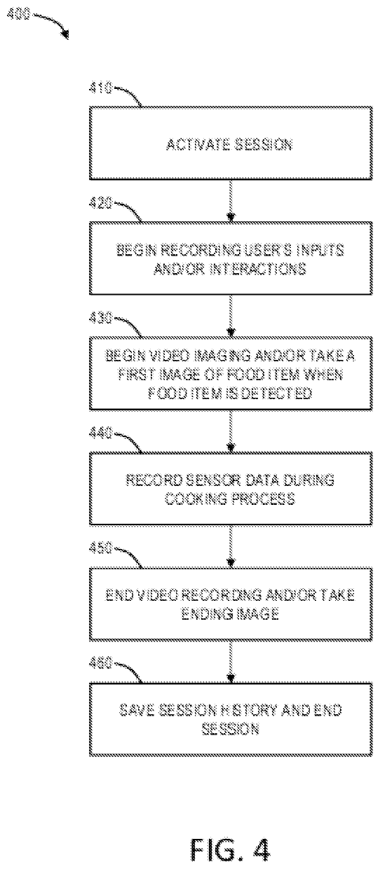

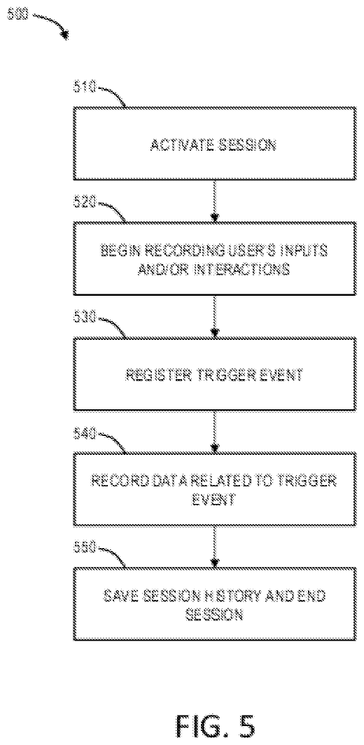

This section describes steps of additional illustrative methods 400 and 500 for recording of cooking sessions utilizing a cooking session recorder device; see FIGS. 4 and 5. Aspects of cooking session re-creation system 100 and cooking session 200 may be utilized in the method steps described below. Where appropriate, reference may be made to components and systems that may be used in carrying out each step. These references are for illustration, and are not intended to limit the possible ways of carrying out any particular step of the method.

FIG. 4 is a flowchart illustrating steps performed in an illustrative method, and may not recite the complete process or all steps of the method. Although various steps of method 400 are described below and depicted in FIG. 4, the steps need not necessarily all be performed, and in some cases may be performed simultaneously or in a different order than the order shown.

Step 410 includes activating the session. This step is substantially similar to step 310 of method 300. In some examples, the recorder and/or cooking appliance may activate an imaging device before beginning recording.

Step 420 includes recording a user's input. Inputs include the mode, mode setting, temperature, and time. The process of recording user's inputs is substantially similar to steps 320, 330, 340, and 350 explained above in method 300. In some examples, a user's interactions may be recorded. Recording interactions may be done through any suitable sensors, such as a door sensor or an imaging device. In some examples, a user's interaction is logged as a cooking event. For example, opening a door may be categorized as a cooking event and recorded as such. Additionally or alternatively, a user's interactions may be recorded but not categorized as a cooking event. For example, a video of the user performing actions during cooking, such as flipping a piece of meat, may be recorded but not categorized as a cooking event when save with the cooking session.

Step 430 includes recording a video and/or taking a first image of the food item. In some examples, the recorder and/or the cooking appliance has an imaging device automatically record a food item and/or take a first image at the start of the cooking process as soon as a food item is detected. Recognition of the food item may be done by the imaging device, the recorder, and/or the cooking appliance using any suitable programming logic configured to detect food, such as machine learning. In some examples, the imaging device collects additional information usable by the recorder and/or cooking appliance to improve re-creation. For example, imaging device configured to collect browning information sends such information to the cooking session re-creation system. This additional information may be used by the cooking session re-creation system to better re-create the cooking process more accurately. Browning information and other such information is record and saved with the cooking session.

Step 440 includes recording sensor data relevant to the cooking process and/or food item characteristics. Collected cooking sessions data may be sent to the recorder and/or to the cooking appliance to be incorporated with recorded user-inputs. In some examples, sensor data is collected one or more times. For example, the final temperature of a food item may be collected once. Additionally or alternatively, sensor data may be collected continuously, to chart the changes that a food item undergoes during the cooking process. For example, humidity may change within the cooking appliance within the cooking time.

Step 450 includes ending the video recording and/or taking a final image of the food item. In some examples, at the end of the cooking process the video image ends and/or a second image is taken at some point before the food item is removed from the cooking appliance. The recorder and/or the cooking appliance may control the imaging device to end the video and/or take a final image

Step 460 includes saving the recorded cooking session and ending the session.

FIG. 5 is a flowchart illustrating steps performed in an illustrative method, and may not recite the complete process or all steps of the method. Although various steps of method 500 are described below and depicted in FIG. 5, the steps need not necessarily all be performed, and in some cases may be performed simultaneously or in a different order than the order shown.

Step 510 includes activating the session. This step is substantially similar to step 310 of method 300.

Step 520 includes recording a user's input. Inputs include the mode, setting, temperature, and time. The process of recording user's inputs is substantially similar to steps 320, 330, 340, and 350 of method 300 and step 420 of method 400 explained above.

Step 530 includes registering trigger events. Trigger events are cooking events that have an associated cooking parameter determined by two or more different user inputs and/or interactions. For example, one possible trigger event may be the attaching of a temperature probe to the food item. Attaching the probe acts as the first interaction and once registered will set the recorder to begin recording data from the probe. Registering the trigger event may be done through signals being sent from the device involved in the trigger event. For example, a probe may send a signal to the recorder and/or cooking appliance once attached to a food item.

Step 540 includes recording data related to the trigger event. In some examples, in response to a second user interaction and/or input the recorder documents a measurement related to the trigger event. For example, once a user removes a temperature probe from a food item the recorder may document a temperature reading from the probe. The measurement may be done by the device related to the trigger event sending the final reading to the recorder and/or cooking appliance, similar to how the trigger event is registered. In some examples, a trigger event happens if the user does not provide certain inputs. For example, if a user activates a burner on a stove top but does not provide a timer, turning a burner on may act as registering a trigger event and the recorder may begin timing the duration of cooking, and turning the burner off serves as the second user interaction so the recorder ends the timer and provides a measured duration.

Step 550 includes saving the recorded cooking session and ending the session. The recorder and/or cooking appliance may save the two actions (e.g., inserting a temperature probe and removing probe) as a single cooking event. For example, “insert temperature probe into food and cook the food until probe reads 165 degrees.” The user may be requested to approve the parameter saved for any trigger events before the cooking session is saved.

### E. Illustrative Method for Organizing Recorded Cooking Sessions

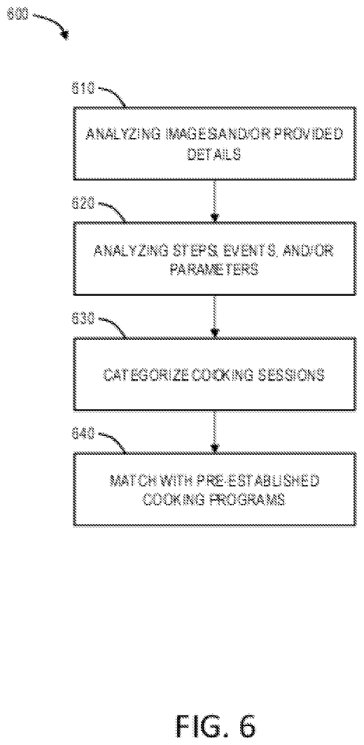

This section describes steps of an illustrative method 600 for organizing recorded cooking sessions; see FIG. 6. Aspects of cooking session re-creation system 100 and cooking session 200 may be utilized in the method steps described below. Where appropriate, reference may be made to components and systems that may be used in carrying out each step. These references are for illustration, and are not intended to limit the possible ways of carrying out any particular step of the method.

FIG. 6 is a flowchart illustrating steps performed in an illustrative method, and may not recite the complete process or all steps of the method. Although various steps of method 600 are described below and depicted in FIG. 6, the steps need not necessarily all be performed, and in some cases may be performed simultaneously or in a different order than the order shown.

Step 610 includes analyzing images and/or provided details of the recorded cooking session using the re-creation system. Images may be collected by an imaging device as described above in method 400 and details may be provided by a user (e.g., the user enters in notes at the end of a cooking session and/or provides a recipe). Analyzing may be done by recorder 110 and/or an electronic controller of cooking appliance 120. Any suitable programming logic, e.g., including machine learning, may be used to analyze the recorded cooking session for step 610 and other steps in method 600.

Step 620 includes analyzing steps, events, and/or parameters in the cooking session. The steps and/or events of the newly recorded cooking session may be compared with previously recorded sessions. Similarities and differences between the new session and the previously recorded sessions may be used to group and/or label the new cooking session. In some examples, substantially similar cooking sessions are associated with the same recipe. For example, several cooking sessions for roast chicken may be grouped by the recorder device based on the food item (chicken) and the similar steps of cooking the food item (oven mode, temperature, etc.). Additionally or alternatively, the cooking session may be compared with a database of standard recipes to find similarities. The database of standard recipes may be stored on the recorder, cooking appliances, and/or the cloud.

Step 630 includes categorizing cooking sessions based on the performed analysis. Categorization may be done by attaching computer readable labels or tags to the cooking session to serve as organizable elements. Categorization may be altered by the user at any point.

Step 640 includes matching the categorized cooking session with one or more cooking programs. These cooking programs are automatic cooking procedures that a user may activate to automatically cook a food item. Cooking programs may be part of the cooking session re-creation system or may be part of a related system present in a cooking appliance (e.g., from an automatic cooking system in the appliance and/or a third-party cooking program system). Matching may be done through any suitable technique of comparing two computer programs. In some examples, matching is similar to the method of categorizing a cooking session, i.e., utilizing features such as the title, steps, cooking events and/or parameters of a cooking session to identify corresponding cooking programs. For example, a cooking session containing instructions for roasting a turkey and a cooking program with instructions similar to the cooking session may be matched together.

### F. Illustrative Cooking Session Selection Screens

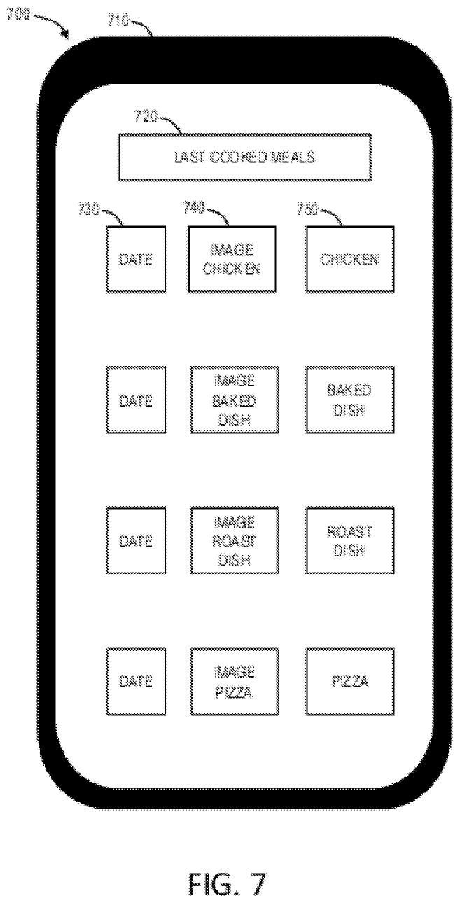

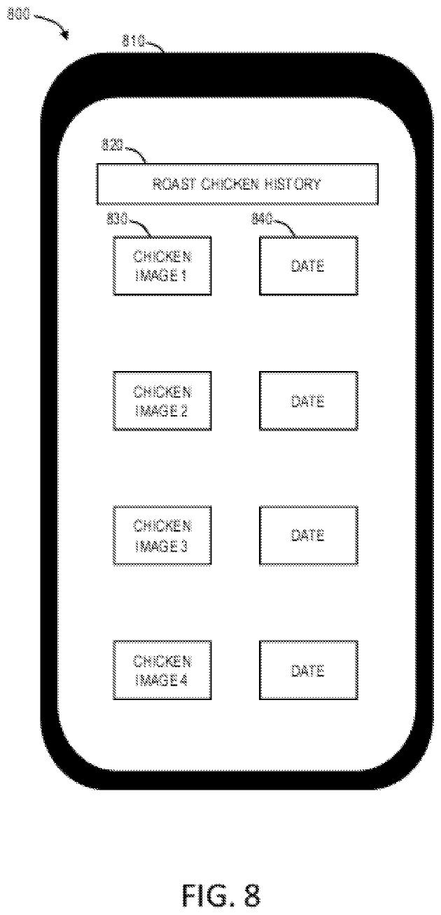

As shown in FIGS. 7-8, this section describes illustrative cooking session selection screens.

Cooking session selection screens 700 and 800 may include any suitable display and/or user interface (UI) configured to present a cooking session history to the user and provide interactivity for the selection of different cooking sessions, such as a touch screen display or other GUI. Selection screens may be part of the cooking appliance, recorder, and/or a user's phone. A user can access cooking sessions through the selection screen. Once accessed, a user may be presented with an information screen of the cooking session such as the one described with respect to illustrative cooking session 200.

Selection screen 700 represents a selection screen having cooking sessions displayed in a chronological order by the date recorded. Selection screen 700 includes a title 720. In some examples, title 720 describes the organization basis by which displayed cooking sessions are ordered (e.g., title “Last cooked meals” describes or reflects the chronological basis). Selection screen 700 also includes a date 730, an image 740, and/or a dish name 750 for each cooking session. In some examples, image 740 is the image recorded by the cooking session re-creation system as described in method 400. Dish name 750 may be provided by the user or automatically generated based on collected information of the food item (e.g., during the categorization process described in method 600 a name may be provided).

In some examples, if the user is interested in seeing only roast chicken cooking sessions, the selection screen is adapted to display all instances of roast chicken Selection screen 800 represents a selection screen having cooking sessions displayed based on the dish type. Title 820 may display what the dish type is. An image 830 provides an image of the dish. Image 830 may be displayed with a date 840. In some examples, the dishes are be displayed in date order, such that the most recent dish of the selected dish type is displayed first (i.e., reverse chronological order).

Other cooking session selection screens may be utilized, including but not limited to selection screens organized by ratings of the user, alphabetically by name of cooking session, length of cooking time, etc. In some examples, multiple organizational schemes may be used at once (e.g., by displaying most recent and highest rated cooking sessions first).

### G. Illustrative Cooking Sessions Re-Creation Method

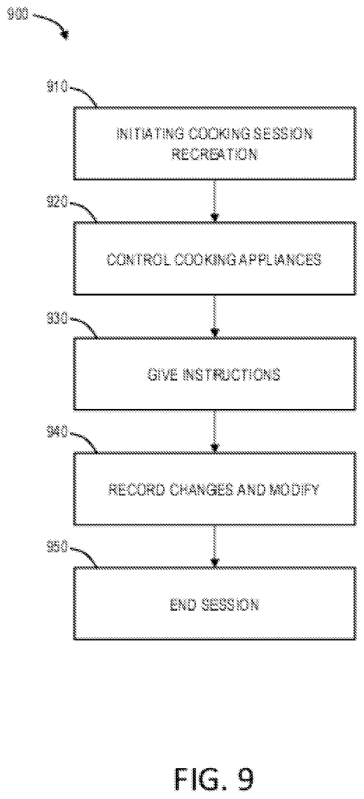

This section describes steps of an illustrative method 900 for re-creating cooking sessions; see FIG. 9. Aspects of cooking session re-creation system 100 and cooking session 200 may be utilized in the method steps described below. Where appropriate, reference may be made to components and systems that may be used in carrying out each step. These references are for illustration, and are not intended to limit the possible ways of carrying out any particular step of the method.

FIG. 9 is a flowchart illustrating steps performed in an illustrative method, and may not recite the complete process or all steps of the method. Although various steps of method 900 are described below and depicted in FIG. 9, the steps need not necessarily all be performed, and in some cases may be performed simultaneously or in a different order than the order shown.

Step 910 includes initiating re-creation of a cooking session. In some examples, a user can start a re-creation of a particular cooking session from the cooking appliance, recorder, and/or a smart phone and other smart devices. Additionally or alternatively, starting the re-creation may be done through a cooking session menu as described above and/or from a selected cooking session as illustrated in FIG. 2. The user may schedule a time for the cooking session re-creation to begin using a connected smart device, the cooking session selection screen, and/or the menu of a selected cooking session.

Step 920 includes controlling and/or managing cooking appliances to re-create the selected cooking session. In some examples, controlling cooking appliances includes sending commands and/or operational instructions to the appliances. Such commands include, but are not limited to, activating and/or selecting a mode, mode setting, temperature, and/or timer. The commands follow the chronological order that was recorded during the cooking session. For example, if a food item was recorded as being baked at 350 degrees for 20 minutes and then broiled for 5 minutes, the cooking session re-creation system will follow that order, first baking the food for 20 minutes and then broiling for 5 minutes, such that the user's cooking process is followed. In some examples, the cooking operation is required to meet a condition before the re-creation process continues. For example, for the duration an appliance is heating to a set temperature, the re-creation system will not control the appliance to set a timer until the set temperature is reached.

In some examples, the recorded duration of cooking events and/or provided timestamps are used during re-creation. For example, the duration of a “bake” mode (determined by the cooking event “setting a timer for 25 minutes” and by the recorded set-up time) is used to operate the baking operation for the 25 minutes after the baking operation is at the requested temperature. Once the duration of a cooking event ends, the recorder proceeds onto the next step. In some examples, the recorder may continue on to the next cooking event before the duration of a previously executed cooking event ends. Once a duration ends, the corresponding cooking operation may be cancelled before moving to the next step. For example, once the duration assigned to a baking mode is completed, the baking mode ends and the oven turns off heating elements.

In some examples, the re-creation system will automatically modify the cooking process. In some such examples, the modification is done to maintain a consistent outcome for the food item being cooked. To achieve this consistency, the re-creation system may utilize the information gathered by the sensors and/or imaging device. For example, if a food item achieved a certain degree of browning during the recorded cooking session, and during re-creation the food item has yet to achieve the same degree of browning during the re-created cooking session, the cooking appliance is controlled (e.g., having temperature and/or the timer changed) such that the same degree of browning is achieved. This modification may be done such that qualities like internal temperature, color, and other food item qualities are consistent, regardless of changing outside variables and/or a change in cooking appliances. The cooking session may be modified in response to being re-created on an appliance different from the appliance used during record. In some examples, modification is done to adjust a cooking session to the different capabilities of an appliance. Modification may be based on measure capabilities of the new appliance (e.g., using device sensor 148). The measured capabilities may be used to add or remove cooking events and/or adjust the parameters of cooking events to achieve the same cooking outcome on the new appliance.

Step 930 includes the cooking session re-creation system providing instructions and/or notifications to the user at any point in the cooking process. Instructions may be sent to perform any actions that a cooking appliance is not capable of doing. For example, a step requiring placing a food item inside the cooking appliance causes the recorder and/or appliance to send an instruction/notification requesting to the user. An additional example are instructions to equip an attachment and/or accessory to the cooking appliance being sent to the user. Instructions may be sent to the recorder, the user's phone, and/or any smart device. For example, once an oven has been automatically preheated by the re-creation system, a message is sent to the user that the oven is ready. In some examples, the user receives notifications providing updates on the cooking process (e.g., a message notifying the user that the timer has 5 minutes left before ending).

Step 940 includes recording any changes made to the cooking session during re-creation and then modifying the cooking session. In some examples, the recorder device still records a user's actions while a cooking session is being re-created. In some such examples, changes made by the user to the recipe during the cooking session re-creation are recorded. For example, the cooking session re-creation system automatically sets an oven to bake at 350 for 20 minutes but a user decides to cook the food for an extra five minutes. This extra time may be automatically added to the cooking session and saved. In some examples, once the user makes the change, the re-creation system halts the current re-creation and requests the user to confirm the changes before continuing. A new cooking session may be saved upon the user confirmation.

Step 950 includes ending the current cooking session re-creation. Upon reaching the end of a cooking session re-creation, the cooking session re-creation system may message the user to confirm ending re-creation or continuing cooking. The user at this point may start a new cooking session re-creation process or end the current cooking session and deactivate the recorder and/or cooking appliances. In some examples, the user may be requested by the re-creation system to rate the outcome of the re-created cooking session. Such rating may be used to organize the cooking sessions in a selection screen. User ratings may be used adjust the cooking session re-creation process. For example, if a user was unsatisfied by the degree a food item was cooked, the cooking session re-creation system uses the rating to automatically adjust the cooking session.

### H. Illustrative Cooking Session Modification Methods

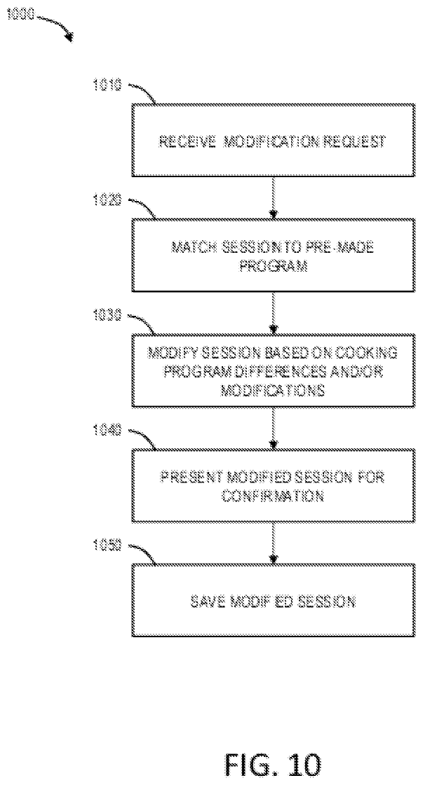

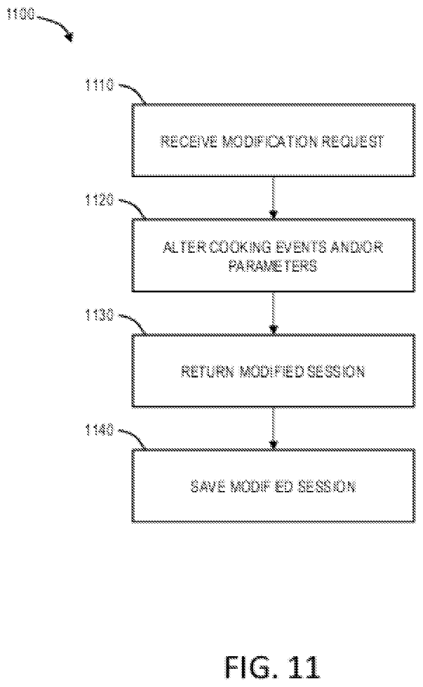

This section describes steps of illustrative methods 1000 and 1100 for modifying cooking sessions to achieve user requested cooking outcomes by adding, removing, and/or editing steps in the cooking session; see FIGS. 10 and 11. Aspects of cooking session re-creation system 100 and cooking session 200 may be utilized in the method steps described below. Where appropriate, reference may be made to components and systems that may be used in carrying out each step. These references are for illustration, and are not intended to limit the possible ways of carrying out any particular step of the method.

FIG. 10 is a flowchart illustrating steps performed in an illustrative method, and may not recite the complete process or all steps of the method. Although various steps of method 1000 are described below and depicted in FIG. 10, the steps need not necessarily all be performed, and in some cases may be performed simultaneously or in a different order than the order shown.

Step 1010 includes receiving a modification request at the cooking session re-creation system. A modification request may be generated from one or more of several different sources. For example, the user may initiate a modification of a cooking session from the recorder, the cooking appliance, and/or the user's phone and any other smart device in communication with the cooking session re-creation system. In some examples, the modification may be automatically initiated by the cooking session re-creation system. For example, the re-creation system may initiate modification of a cooking session in response to a food item's weight measurements. The modification request may be sent to the recorder and/or the cooking appliance to be fulfilled. The modification request may include a request to modify the cooking session to achieve a cooking outcome. Cooking outcomes are the final characteristics of a food item after the cooking process is done, such as coloration, doneness, etc.

Step 1020 includes the re-creation system matching the cooking session to a cooking program. Matching may be done by any suitable programing logic, e.g., including the use of machine learning models. In some examples, the cooking session may be already matched to an automatic cooking program as part of the categorization process described in method 600. Additionally or alternatively, matching may be done at step 1020 in a substantially similar process described in method 600, e.g., utilizing features such as the title, steps, cooking events and/or parameters of a cooking session to identify corresponding cooking programs.

Step 1030 includes modifying the cooking session. The modification process may include the use of any suitable programs that change the cooking session to achieve the requested cooking outcome. In some examples, modification is achieved by first modifying the matched cooking program and then applying the modifications to the cooking session. In some such examples, the cooking appliance has an algorithm and/or machine learning capabilities configured to modify cooking programs such that the same modifications are applicable to a matched cooking session. For example, a cooking appliance may be configured to modify a cooking program for roast turkey and any modifications made to the cooking program, such as adding or removing an operation, are applicable to a matched cooking session, such that the cooking session is modified similarly to the cooking program and achieves the same outcome as the modified cooking program.

Additionally or alternatively, a cooking session may be altered to match (have steps add or removed and/or parameters changed) the cooking program option most closely resembling the user's requested outcome. For example, a cooking program may consistently produce food items with the qualities requested by the user. The cooking session may be modified such that the session matches the cooking program, at least for relevant steps and/or settings.

Step 1040 includes presenting and/or displaying the modified cooking session. At this point, the user may accept or reject the modified session. In some examples, the user may request further modification at this step.

Step 1050 includes saving the modified session as a new program. In some examples, the user may request that the modified session replace (i.e., overwrite) the previous version of the same session. The session may be saved on the recorder, a cooking appliance, and/or a cloud service.

In some examples, there are no cooking programs that match a cooking session, and the re-creation system uses method 1110, as depicted in FIG. 11, to modify a cooking session without matching the cooking session to a cooking program. FIG. 11 is a flowchart illustrating steps performed in an illustrative method, and may not recite the complete process or all steps of the method. Although various steps of method 1100 are described below and depicted in FIG. 11, the steps need not necessarily all be performed, and in some cases may be performed simultaneously or in a different order than the order shown.

Step 1110 includes receiving a modification request. This step is substantially similar to step 1010 in method 1000.

Step 1120 includes altering cooking events and/or parameters of the cooking session. Altering cooking events and/or parameters may be done with programming logic suitable for predicting how a cooking events and parameters affect the outcome of a dish, such as machine learning. In some examples, the re-creation system adds steps automatically to the cooking session to match the requested outcome modification. For example, if a user requests that crispier outcome for a roasted dish, the re-creation system adds a high temperature broiling step with a timer to the cooking session. Additionally or alternatively, the re-creation system may alter the parameters of already present steps to reach the requested outcome. For example, if a roasted dish already has a broiling step for crisping, the re-creation system then increases the temperature and/or the time to achieve the requested outcome.

Step 1040 includes presenting and/or displaying the modified cooking session. At this point, the user may accept or reject the modified session. In some examples, the user may request further modification at this step.

Step 1140 includes saving the modified cooking session. This step is substantially similar to step 1050 of method 1000.

### I. Illustrative Machine Learning Algorithm

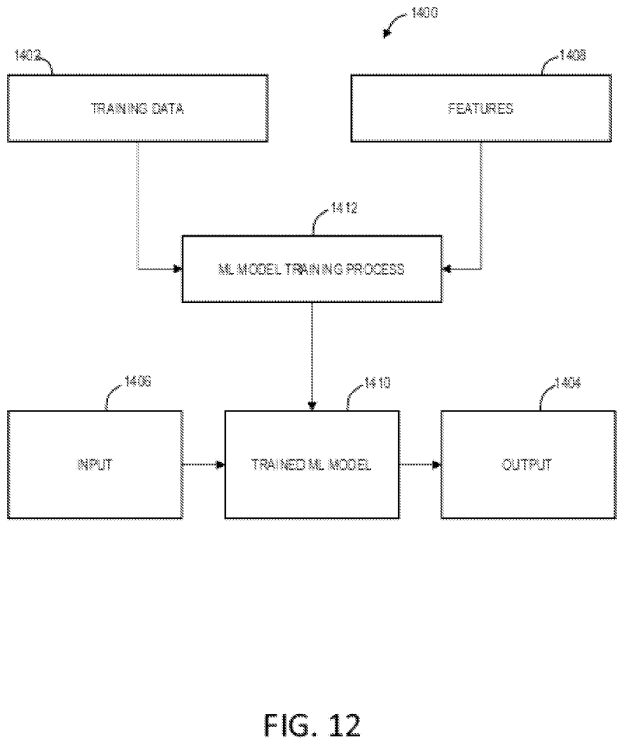

FIG. 12 depicts the training and use of an illustrative machine learning algorithm or model 1200. As mentioned above, machine learning algorithms may be utilized in one or more conversion aspects of cooking session re-creation system 100 (and/or other systems described herein).

In general, machine learning (ML) models (AKA ML algorithms, ML tools, or ML programs) may be utilized to generate predictions or decisions that are useful in themselves and/or in the service of a more comprehensive program. ML algorithms “learn” by example, based on existing sample data, and generate a trained model. Using the trained model, predictions or decisions can then be made regarding new data without explicit programming. Machine learning therefore involves algorithms or tools that learn from existing data and make predictions about novel data.

Training data 1202 (e.g., labeled training data) is utilized to build trained ML model 1200, such that the ML model can produce a desired output 1204 when presented with new data 1206. In general, the ML model uses labeled training data 1202, which includes values for the input variables and values for the known correct outputs, to ascertain relationships and correlations between variables or features 1208 to produce an algorithm mapping the input values to the outputs.

Supervised learning methods may be utilized for the purposes of producing classification or regression algorithms. Classification algorithms are typically used in situations where the goal is categorization (e.g., whether a photo contains a cat or a dog). Regression algorithms are typically used in situations where the goal is a numerical value (e.g., the market value of a house).

Features 1208 may include any suitable characteristics capable of being measured and configured to provide some level of information regarding the input scenario, situation, or phenomenon. For example, if the goal is to provide an output relating to the market value of a house, then the features may include variables such as square footage, postal code, year built, lot size, number of bedrooms, etc. Although these example features are numeric, other feature types may be included, such as strings, Boolean values, etc.

Different ML techniques may be used, depending on the application. For example, artificial neural networks, decision trees, support-vector machines, regression analysis, Bayesian networks, genetic algorithms, random forests, and/or the like may be utilized to produce the trained ML model.

Trained ML model 1200 is produced by training process 1210 based on identified features 1208 and training data 1202. Trained ML model 1200 can then be utilized to predict a category or decide an output value 1204 based on new data 1206.

With respect to the present disclosure, one or more ML models may be trained and used during the re-creation of a cooking session. Training data for one or more of the ML models may include recorded cooking sessions, pre-made cooking programs, and/or user feedback such that the ML models are trained to automatically adjusts a cooking session to match a recorded outcome. For example, if a food item has yet to achieve a recorded temperature by the end of the timer recorded in the cooking session, a ML model automatically adds more time and/or adjust the temperature such that the food item reaches the recorded temperature.

In some examples, one or more ML models are trained and used to match cooking session to pre-made cooking programs and modify cooking sessions based on modifications to a corresponding cooking program. For example, one or more ML models analyze the images, title, cooking events, and/or user's notes to determine what a cooking session food item and cooking process is, then compares the identified food item and cooking process to pre-made programs. Training data may be the cooking sessions, cooking programs, and/or recipe databanks. Additionally or alternatively, one or more ML models may be trained and used to automatically modify cooking sessions.

### J. Illustrative Combinations and Additional Examples

This section describes additional aspects and features of cooking session re-creation system, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A computer-implemented method for operating a cooking appliance, the method comprising:
automatically recording, using a controller of a cooking appliance, a plurality of sequential user inputs at the cooking appliance during a cooking process of a food item;
automatically generating, based on the plurality of sequential user inputs, a cooking session program configured to re-create the cooking process by automatically controlling the cooking appliance; and
automatically controlling the cooking appliance to re-create the cooking process using the cooking session program.

A1. The method of A0, wherein automatically generating the cooking session program further includes converting the recorded user inputs into a set of operational instructions executable by the controller of the cooking appliance.

A2. The method of A0 or A1, wherein the plurality of sequential user inputs include a cooking mode and a temperature setting.

A3. The method of any one of paragraphs A0 through A2, further including automatically recording a video image of the food item during the cooking process using an imaging device of the cooking appliance.

A4. The method of any one of paragraphs A0 through A3, further including automatically measuring one or more characteristics of the food item during the cooking process using one or more sensors; and wherein automatically controlling the cooking appliance to re-create the cooking process includes automatically adjusting the cooking session program to re-create the one or more characteristics of the food item.

A5. The method of any one of paragraphs A0 through A4, further including:
receiving a request to modify a cooking outcome, wherein the cooking outcome includes one or more characteristics of the food item at an end phase of the cooking process; and
automatically modifying the cooking session using the controller to achieve the requested cooking outcome.

A6. The method of A5, wherein the one or more characteristics includes a crispiness level of the food item.

B0. A computer-implemented method for operating a cooking appliance, the method comprising:
automatically recording, using processing logic, a plurality of sequential user inputs at the cooking appliance during a cooking process of a food item;
documenting a characteristic of a finished version of the food item by automatically generating an image of the food item at an end stage of the cooking process;
automatically generating, using the processing logic and based on the recorded user inputs, a cooking session program configured to re-create the cooking process, including the sequential user inputs, by automatically controlling the cooking appliance; and
automatically controlling the cooking appliance to re-create the cooking process using the cooking session program, wherein the processing logic automatically modifies the cooking session program to obtain the characteristic of the finished version of the food item.

B1. The method of B0, wherein automatically generating the cooking session program further includes converting the plurality of sequential user inputs into a set of operational instructions executable by a controller of the cooking appliance.

B2. The method of B1, wherein the processing logic comprises the controller of the cooking appliance.

B3. The method of any one of paragraphs B0 through B2, further including automatically measuring one or more further characteristics of the food item during the cooking process using one or more sensors; and wherein automatically controlling the cooking appliance to re-create the cooking process includes automatically adjusting the cooking session program to re-create the one or more further characteristics of the food item.

B4. The method of any one of paragraphs B0 through B3, further including:
receiving a request to modify a cooking outcome relating to a quality of the food item; and
automatically modifying the cooking session using the processing logic to achieve the requested modification.

B5. The method of any one of paragraphs B0 through B4, wherein the characteristic of the finished version of the food item is a level of browning.

B6. The method of any one of paragraphs B0 through B5, wherein the processing logic comprises a recording device separate from the cooking appliance.

C0. A computer-implemented method for operating a cooking appliance, the method comprising:
automatically recording, using processing logic, a plurality of sequential user inputs at the cooking appliance during a cooking process of a food item;
automatically recording, using one or more sensors, a plurality of characteristics of the food item and the cooking appliance during the cooking process;
automatically generating, based on the recorded user inputs, the recorded characteristics of the food item, and the recorded characteristics of the cooking appliance, a cooking session program configured to re-create the cooking process by automatically controlling the cooking appliance.

C1. The method of C0, further comprising automatically controlling the cooking appliance to re-create the cooking process using the cooking session program.

C2. The method of C0 or C1, wherein automatically generating the cooking session program further includes converting the one or more recorded user inputs into a set of operational instructions executable by a controller of the cooking appliance.

C3. The method of any one of paragraphs C0 through C2, further comprising:
receiving a request to modify a cooking outcome relating to a quality of the food item; and
automatically modifying the cooking session using the processing logic to achieve the requested modification.

C4. The method of any one of paragraphs C0 through C3, wherein the processing logic comprises a recording device separate from the cooking appliance.

C5. The method of any one of paragraphs C0 through C4, wherein the processing logic comprises a controller of the cooking appliance.

C6. The method of any one of paragraphs C0 through C5, wherein recording of a selected one of the characteristics of the food item is triggered by the occurrence of a selected one of the user inputs.

C7. The method of C6, wherein recording of the selected one of the characteristics of the food item is performed over time (e.g., a temperature probe measurement ongoing for a time duration to obtain average, maximum, and/or final temperature of the food item).

### Advantages, Features, and Benefits

The different embodiments and examples of the cooking session re-creation system described herein provide several advantages over known solutions. For example, illustrative embodiments and examples described herein allow a user to create an automatic program based on their own cooking habits.

Additionally, and among other benefits, illustrative embodiments and examples described herein allow a user to easily experiment and/or change recipes and have the process recorded automatically, including the individual steps taken during the cooking process. The user is not required to rely on memory or handwritten notes.

Additionally, and among other benefits, illustrative embodiments and examples described herein allow a user to playback, re-create, emulate, and/or simulate the automatic program.

Additionally, and among other benefits, illustrative embodiments and examples described herein allow for a recording device to effectively organize multiple cooking sessions for improved ease of access.

Additionally, and among other benefits, illustrative embodiments and examples described herein allow a user to view an organized history of their cooking to observe improvements and/or patterns.

Additionally, and among other benefits, illustrative embodiments and examples described herein allow a user to easily modify the outcome of a recipe by specifying the outcome, i.e., without having to manually change steps of the recipe.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A computer-implemented method for operating a cooking appliance, the method comprising:
automatically recording, using a controller of a cooking appliance, a plurality of sequential user inputs at the cooking appliance during a cooking process of a food item;
automatically generating, based on the plurality of sequential user inputs, a cooking session program configured to re-create the cooking process by automatically controlling the cooking appliance; and
automatically controlling the cooking appliance to re-create the cooking process using the cooking session program.

2. The method of claim 1, wherein automatically generating the cooking session program further includes converting the recorded user inputs into a set of operational instructions executable by the controller of the cooking appliance.

3. The method of claim 1, wherein the plurality of sequential user inputs include a cooking mode and a temperature setting.

4. The method of claim 1, further including automatically recording a video image of the food item during the cooking process using an imaging device of the cooking appliance.

5. The method of claim 1, further including automatically measuring one or more characteristics of the food item during the cooking process using one or more sensors; and wherein automatically controlling the cooking appliance to re-create the cooking process includes automatically adjusting the cooking session program to re-create the one or more characteristics of the food item.

6. The method of claim 1, further including:
receiving a request to modify a cooking outcome, wherein the cooking outcome includes one or more characteristics of the food item at an end phase of the cooking process; and
automatically modifying the cooking session using the controller to achieve the requested cooking outcome.

7. The method of claim 6, wherein the one or more characteristics includes a crispiness level of the food item.

8. A computer-implemented method for operating a cooking appliance, the method comprising:
automatically recording, using processing logic, a plurality of sequential user inputs at the cooking appliance during a cooking process of a food item;
documenting a characteristic of a finished version of the food item by automatically generating an image of the food item at an end stage of the cooking process;
automatically generating, using the processing logic and based on the recorded user inputs, a cooking session program configured to re-create the cooking process, including the sequential user inputs, by automatically controlling the cooking appliance; and
automatically controlling the cooking appliance to re-create the cooking process using the cooking session program, wherein the processing logic automatically modifies the cooking session program to obtain the characteristic of the finished version of the food item.

9. The method of claim 8, wherein automatically generating the cooking session program further includes converting the plurality of sequential user inputs into a set of operational instructions executable by a controller of the cooking appliance.

10. The method of claim 9, wherein the processing logic comprises the controller of the cooking appliance.

11. The method of claim 8, further including automatically measuring one or more further characteristics of the food item during the cooking process using one or more sensors; and wherein automatically controlling the cooking appliance to re-create the cooking process includes automatically adjusting the cooking session program to re-create the one or more further characteristics of the food item.

12. The method of claim 8, further including:
receiving a request to modify a cooking outcome relating to a quality of the food item; and
automatically modifying the cooking session using the processing logic to achieve the requested modification.

13. The method of claim 8, wherein the characteristic of the finished version of the food item is a level of browning.

14. The method of claim 8, wherein the processing logic comprises a recording device separate from the cooking appliance.

15. A computer-implemented method for operating a cooking appliance, the method comprising:
automatically recording, using processing logic, a plurality of sequential user inputs at the cooking appliance during a cooking process of a food item;
automatically recording, using one or more sensors, a plurality of characteristics of the food item and the cooking appliance during the cooking process;
automatically generating, based on the recorded user inputs, the recorded characteristics of the food item, and the recorded characteristics of the cooking appliance, a cooking session program configured to re-create the cooking process by automatically controlling the cooking appliance.

16. The method of claim 15, further comprising automatically controlling the cooking appliance to re-create the cooking process using the cooking session program.

17. The method of claim 15, wherein automatically generating the cooking session program further includes converting the one or more recorded user inputs into a set of operational instructions executable by a controller of the cooking appliance.

18. The method of claim 15, further comprising:
receiving a request to modify a cooking outcome relating to a quality of the food item; and
automatically modifying the cooking session using the processing logic to achieve the requested modification.

19. The method of claim 15, wherein the processing logic comprises a recording device separate from the cooking appliance.

20. The method of claim 15, wherein recording of a selected one of the characteristics of the food item is triggered by the occurrence of a selected one of the user inputs.
